(19) United States
(12) Patent Application Publication
(10) Pub. No.: US 2019/0100044 A1
(43) Pub. Date: Apr. 4, 2019

(54) PRINTERS, PRINTER SPINDLE ASSEMBLIES, AND METHODS FOR DETERMINING MEDIA WIDTH FOR CONTROLLING MEDIA TENSION

(71) Applicant: Datamax-O'Neil Corporation, Orlando, FL (US)

(72) Inventors: Eng Hing Lim, Singapore (SG); Yaw Horng Yap, Singapore (SG); Aravindkumar Harinarayanan, Singapore (SG)

(21) Appl. No.: 15/724,788

(22) Filed: Oct. 4, 2017

(51) Int. Cl. B41J 15/02; B41J 2/315

(52) U.S. Cl. CPC B41J 15/02; B41J 2/315

(57) ABSTRACT

Printer spindle assembly is provided including media spindle having first end and second end, a commutator disposed circumferentially at first end, at least two brushes in electrical contact with commutator and connected to voltage source, a plurality of electrically conductive springs serially disposed on media spindle in electrical communication with commutator, and a continuous electrically conductive path formed of electrically resistive material disposed along longitudinal axis of media spindle and configured to be in electrical contact with first spring end of one or more electrically conductive springs in the compressed state to form series circuit. Voltage source, brushes, and commutator form closed electrical circuit. Each electrically conductive spring is configured to be in uncompressed state in absence of media on media spindle and one or more of electrically conductive springs is configured to be in compressed state in presence of media on media spindle.

### FIELD OF THE INVENTION

The present invention relates to printers and, more particularly, relates to printer spindle assemblies and methods for determining media width for controlling media tension.

### BACKGROUND

Generally speaking, printers employ media on printer spindle assemblies. As used herein, “media” is any consumable product used in the printer (e.g., labels, receipts, ink ribbon, etc.). The term “media” includes “print media” on which the printer prints as well as the ink ribbon that may supply ink. Media of different widths have different torque requirements. Incorrect torque (i.e., media tension) may result in poor print quality, media wrinkles, print registration problems, black bending on printouts, and in some case, media rupture (collectively “printing problems”). Thus, it is important for the media tension to be set appropriate to the media width.

While systems exist to automatically sense the size of print media loaded into a printer by having an electrical feedback connected to the media size adjustment mechanism, such systems do not tell the printer or user anything about the proper torque values (i.e., media tension) to be used for any given printing job and for media other than print media.

Therefore, a need exists for printers, and printer spindle assemblies thereof and methods for automatically determining media width for controlling media tension.

### SUMMARY

Accordingly, in one aspect, the present invention embraces a printer spindle assembly comprising a media spindle having a first end and a second end, a commutator disposed circumferentially at the first end of the media spindle, at least two brushes in electrical contact with the commutator and connected to a voltage source, a plurality of electrically conductive springs serially disposed on the media spindle in electrical communication with the commutator, and a continuous electrically conductive path formed of electrically resistive material disposed along a longitudinal axis of the media spindle and configured to be in electrical contact with a first end of the one or more electrically conductive springs in the compressed state to form a series circuit. The voltage source, the at least two brushes, and the commutator form a closed electrical circuit. Each electrically conductive spring is configured to be in an uncompressed state in the absence of media on the media spindle and one or more of the electrically conductive springs is configured to be in a compressed state in the presence of the media on the media spindle.

In another aspect, the present invention embraces a printer comprising a spindle assembly and a processor. The spindle assembly comprises a media spindle having a first end and a second end, a commutator disposed circumferentially at the first end of the media spindle, at least two brushes in electrical contact with the commutator and connected to a voltage source, a plurality of electrically conductive springs serially disposed on the media spindle in electrical communication with the commutator, and a continuous electrically conductive path formed of electrically resistive material disposed along a longitudinal axis of the media spindle and configured to be in electrical contact with a first end of the one or more electrically conductive springs in the compressed state to form a series circuit. The voltage source, the at least two brushes, and the commutator form a closed electrical circuit. Each electrically conductive spring is configured to be in an uncompressed state in the absence of media on the media spindle and one or more of the conductive springs is configured to be in a compressed state in the presence of the media on the media spindle. The processor is configured to determine a width of the media loaded on the media spindle based on the resistance of the series circuit and is configured to adjust torsion on the media based upon the determined width of the media.

In another aspect, the present invention embraces a method comprising loading media on a media spindle of a printer spindle assembly. The media spindle has a first end and a second end and the printer spindle assembly comprises a commutator disposed circumferentially at the first end of the media spindle, at least two brushes in electrical contact with the commutator and connected to a voltage source, a plurality of electrically conductive springs serially disposed on the media spindle in electrical communication with the commutator, and a continuous electrically conductive path formed of electrically resistive material disposed along a longitudinal axis of the media spindle and configured to be in electrical contact with a first end of the one or more electrically conductive springs in the compressed state to form a series circuit. The voltage source, the at least two brushes, and the commutator form a closed electrical circuit. Each electrically conductive spring is configured to be in an uncompressed state in the absence of the media on the media spindle and one or more of the electrically conductive springs is configured to be in a compressed state in the presence of the media on the media spindle. At least two brushes are connected to a voltage source. An electrical resistance of the series circuit is determined. A width of the media loaded on the media spindle is determined from the electrical resistance.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 graphically illustrates a portion of an exemplary printer comprising a printer spindle assembly (two exemplary printer spindle assemblies) in accordance with various embodiments of the present invention, a cover of the printer removed (i.e., an open printer) to illustrate an interior of the printer including a portion of the printer spindle assembly, according to various embodiments of the present invention;

FIG. 2 graphically depicts one of the printer spindle assemblies of FIG. 1, according to various embodiments of the present invention;

FIG. 3 graphically depicts another view of the printer spindle assembly of FIG. 2, according to various embodiments of the present invention;

FIGS. 4A and 4B graphically compare the measured resistance between three-inch wide media (ribbon in the depicted embodiment) (FIG. 4A) versus the measured resistance of one-inch wide media (FIG. 4B), the three-inch wide media resulting in a lower resistance series circuit relative to the one-inch wide media, according to various embodiments of the present invention;

FIG. 5A graphically depicts the compressed and uncompressed electrically conductive springs of the printer spindle assembly of FIG. 2, according to various embodiments of the present invention;

FIG. 5B graphically depicts the compressed electrically conductive springs contacting resistive material of the printer spindle assembly resulting in current flow, according to various embodiments of the present invention;

FIG. 6 is an end view of the printer spindle assembly of FIG. 2, illustrating a compressed electrically conductive spring and an uncompressed electrically conductive spring, according to various embodiments of the present invention;

FIG. 7A graphically depicts the compressed electrically conductive springs contacting the resistive material of the printer spindle assembly, according to various embodiments of the present invention;

FIG. 7B depicts a second spring end of one of the uncompressed electrically conductive springs received and retained in a groove within the media spindle of the printer spindle assembly of FIG. 2, according to various embodiments of the present invention;

FIG. 8A depicts a series circuit used in the methods according to various embodiments as compared with the conventionally used parallel circuit depicted in FIG. 8B; and

FIG. 9 is a flow diagram of a method for determining media width for controlling media tension, according to various embodiments of the present invention.

### DETAILED DESCRIPTION

The present invention embraces printers, and printer spindle assemblies thereof and methods for automatically determining media width for controlling media tension. Various embodiments provide an automatic system that can sense the width of media disposed on a printer spindle assembly and feedback this information to an onboard processor that can implement torque requirements to achieve correct media tension.

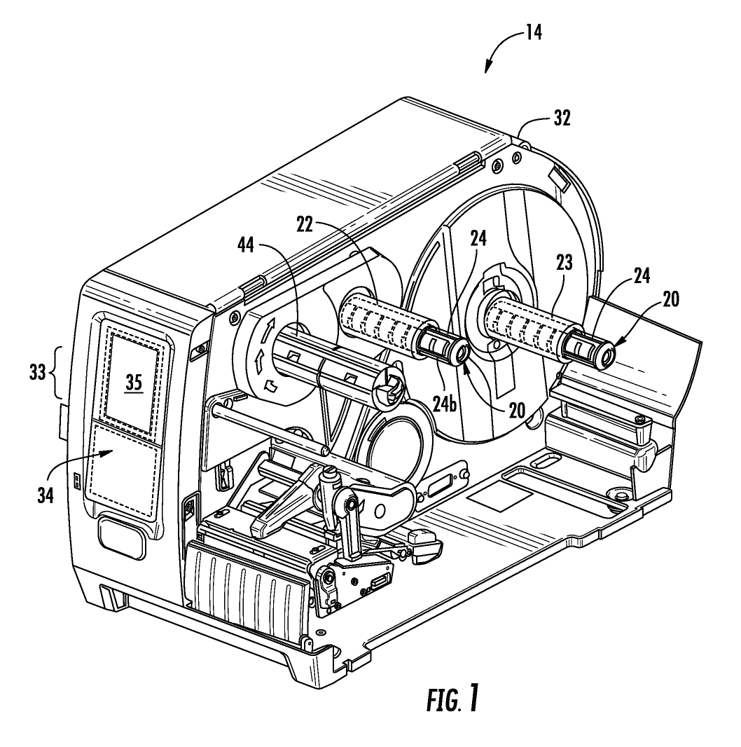

Various embodiments of the present invention will be described in relation to a thermal transfer printer such as depicted in FIG. 1. However, the present invention may be equally applicable to other types and styles of printers (e.g., a thermal direct printer, a laser toner printer, an ink drop printer, etc.). As used herein, the term “printer” refers to a device that prints text, barcodes and other information-bearing symbols, illustrations, etc. onto non-continuous and continuous print media as hereinafter described (e.g., labels, receipts, paper, etc.). Non-continuous print media may comprise a liner portion underlying a plurality of individual print medium (a print medium portion) (e.g., a label) to define a liner only portion between each of the individual print medium. The individual print medium may be separated on the liner by gaps, holes, notches, black marks, etc. As used herein, “media” is any consumable product used in the printer (e.g., labels, receipts, ribbon, etc.). The term “media” includes “print media” on which the printer prints as well as the ribbon that may supply ink that transfers onto the print media.

Referring now specifically to FIG. 1, according to various embodiments of the present invention, an exemplary (thermal transfer) printer 14 capable of printing on print media is partially shown. The depicted printer 14 has a body 32 for enclosing an interior thereof. A moveable cover that forms a portion of the body is removed in FIG. 1 for purposes of illustration. The moveable cover permits access to, for example, the interior of the body 32 and the components contained therein.

In the case of a thermal transfer printer such as depicted in FIG. 1, there may be at least one printer spindle assembly 20 contained within the body 32, in accordance with various embodiments of the present invention. FIG. 1 depicts printer spindle assembly 20 configured to hold a ribbon supply roll 22 and another printer spindle assembly 20 configured to hold a print media supply roll 23 within the body of the printer.

The ribbon supply roll and the print media supply roll comprise exemplary “media rolls”. As hereinafter described, a media roll is configured to be disposed on a media spindle 24 of the printer spindle assembly 20. For example, the ribbon supply roll comprising ribbon (exemplary media) wound on a media supply spool is configured to be disposed on a media spindle comprising a ribbon supply spindle. The print media supply roll comprising print media wound on a print media supply spool is configured to be disposed on a media spindle comprising a print media supply spindle. As used herein, the media width is equivalent to the media roll width. The media spindle comprises a hollow elongated substantially cylindrical member comprised of a nonconductive material according to various embodiments of the present invention. A ribbon rewind spindle 44 on which unwound ribbon is wound up may also be contained within the body 32. Each of the media spindles and the media rolls disposed thereon are configured to rotate.

The printer 14 further comprises a processor 33. As known in the art, the central processing unit (CPU) (i.e., the processor 33) is the electronic circuitry within a computer that carries out the instructions of a computer program by performing the basic arithmetic, logical, control and input/output (I/O) operations specified by the instructions as hereinafter described. According to various embodiments of the present invention as hereinafter described, the processor is configured to determine the width of the media loaded on the media spindle through feedback from resistance circuitry coupled to the processor. Once the media width is known to the processor, the processor causes an adjustment in media tension in accordance with the media width. The processor is further configured to implement torque requirements of the printer. By adjusting the torque requirements, the media tension is changed. The processor may be configured to send information on the width of the media loaded on the media spindle to a display 35 on the printer.

The printer further comprises other illustrated and non-illustrated components as known in the art. For example, the printer may further comprise one or more motors (not shown) for rotating the media spindle(s) and the media rolls disposed thereon, and a user interface 34 for communication between a user and the printer 14. The user interface 34 may include, but is not limited to, the printer display 35 for displaying information, including information on the width of the media loaded on the media spindle.

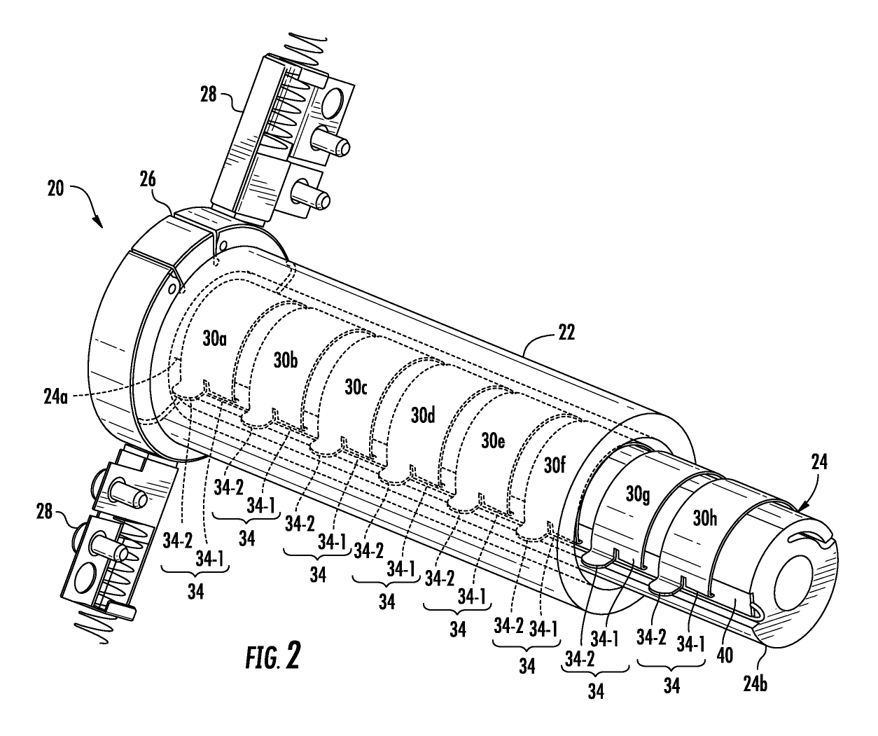

Returning now to FIG. 2, according to various embodiments of the present invention, the printer spindle assembly 20 comprises the media spindle 24 having a first end 24a and a second end 24b, a commutator 26 (not shown in FIG. 1) disposed circumferentially at the first end 24a of the media spindle, at least two (carbon) brushes 28 (not shown in FIG. 1) in electrical contact with the commutator 26 and connected to a voltage source, a plurality of electrically conductive springs (e.g., 30a-30h) serially disposed on the media spindle 24 in electrical communication with the commutator, and a continuous electrically conductive path 40 formed of electrically resistive material disposed along a longitudinal axis of the media spindle and configured to be in electrical contact with a first spring end portion 34-1 of one or more of the electrically conductive springs in the compressed state to form a series circuit. The media spindle 24, the plurality of electrically conductive springs (e.g., 30a-30h in the depicted embodiment), and the continuous electrically conductive path 40 comprising the electrically resistive material comprise a rotational potentiometer. The width of the spring can be selected to accommodate the media width.

The electrically conductive spring 30 are electrically linked to the commutator 26. The carbon brushes 28 are disposed generally on either side of the commutator 26. The voltage source, the carbon brushes, and the commutator form a closed electrical circuit. The closed electrical circuit connects the electrical circuits in series to a main electrical control unit housing the processor 33 (FIG. 1) of the printer. A meter comprising an analog to digital converter (ADC) is coupled to the processor 33. The ADC provides an isolated measurement that converts an analog voltage or current to a digital number proportional to the magnitude of the voltage or current. The processor is configured by a software program to implement torque requirements to achieve correct media tension as hereinafter described.

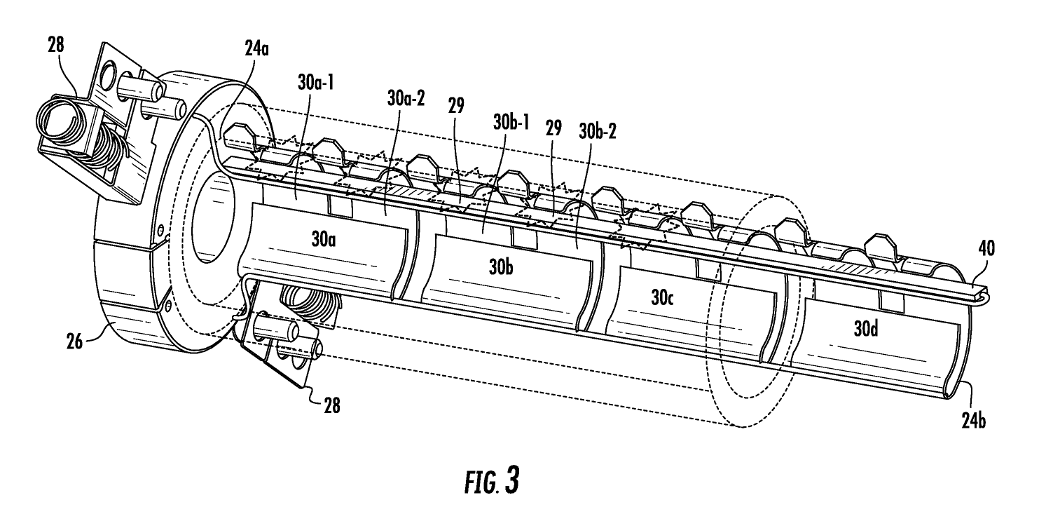

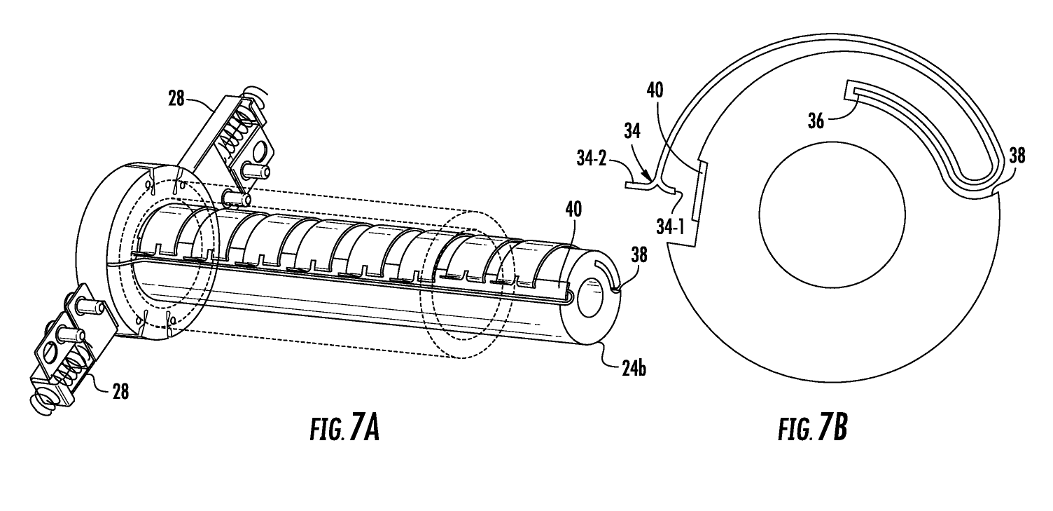

Still referring to FIG. 2 and now to FIGS. 3, 6, and 7B, the plurality of electrically conductive springs (30a-30h in FIG. 2) disposed on the media spindle 24 are generally C-shaped. Suitable exemplary electrically conductive springs include a leaf spring/coil spring. Each electrically conductive spring 30 comprises a pair of conjoined electrically conductive spring portions having a space therebetween to impart compressibility to each electrically conductive spring. Each electrically conductive spring has two spring ends, the first spring end 34 and a second spring end 36. The first spring end 34 gets compressed. The first spring end 34 has a first portion 34-1 facing a first direction that is used to contact the resistive material and a second portion 34-2 facing a second opposing direction that provides a surface for the media roll to contact and compress the first spring end 34. As noted previously, the first spring end 34 is configured to be compressed (deflected) when a media roll (e.g., ribbon supply roll 22) is disposed on the media spindle 24. The second spring end 36 of each electrically conductive spring is configured to be received and retained in a groove 38 (see FIG. 7B) in the media spindle. Each electrically conductive spring is metallic.

In the depicted embodiment of FIG. 2, the printer spindle assembly has eight electrically conductive springs. In the depicted embodiment of FIG. 3, the printer spindle assembly has four electrically conductive springs; however other numbers of electrically conductive springs are possible. The first electrically conductive spring disposed near the first end of the media spindle is contiguous to the commutator. The subsequent electrically conductive springs are spaced apart in serial arrangement on the media spindle in the direction of the media spindle second end. The electrically conductive springs remain in an uncompressed state when no media roll is loaded on the media spindle of the printer spindle assembly.

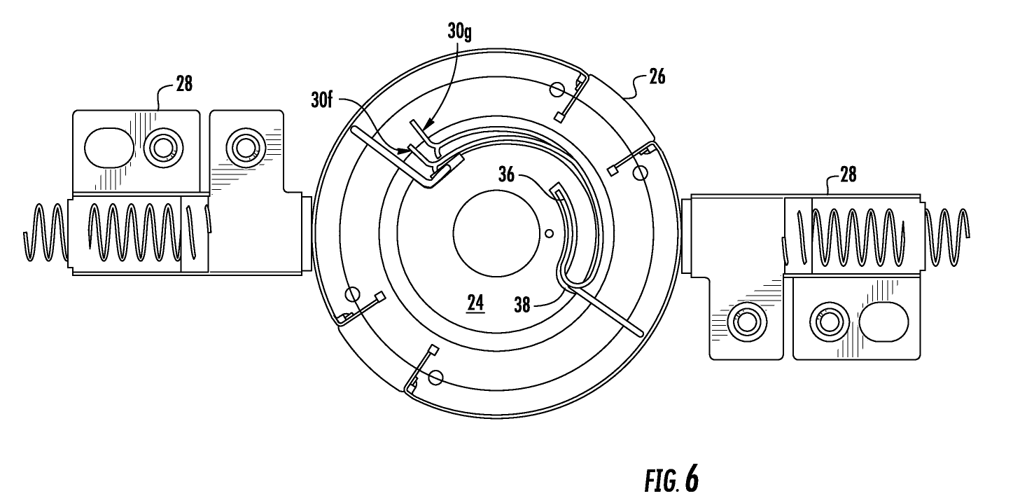

When a media roll is disposed on the media spindle of the printer spindle assembly, the media roll compresses one or more of the electrically conductive springs. The media roll will contact the second portion 34-2 and then the first portion 34-1 of the electrically conductive springs will touch the conductive path 40 as noted previously. Therefore, each electrically conductive spring is configured to be in an uncompressed state in the absence of media on the media spindle and one or more of the electrically conductive springs is configured to be in a compressed state in the presence of the media on the media spindle. In FIG. 2, electrically conductive springs 30a-30f are in a compressed state and electrically conductive springs 30g-30h are in an uncompressed state. In FIG. 3, electrically conductive springs 30a-30c are in a compressed state and electrically conductive spring 30d is in an uncompressed state. In FIG. 6, electrically conductive spring 30f is in the compressed state and electrically conductive spring 30g is in the uncompressed state.

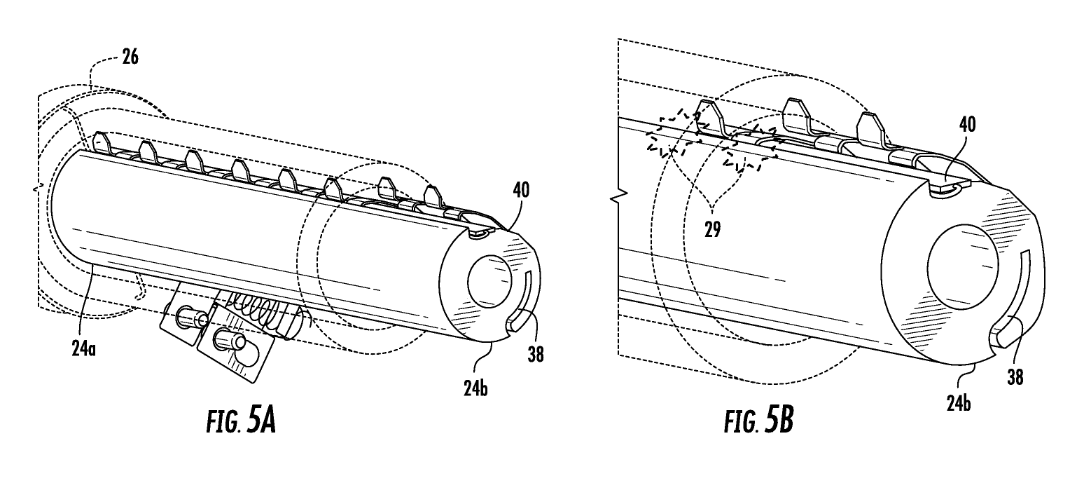

The electrically conductive springs have a length such that when one or more of the electrically conductive springs are compressed, the first spring end of the compressed electrically conductive spring(s) will make electrical contact with the continuous electrically conductive path 40, resulting in current 29 flow (e.g., FIGS. 3, 5A, 5B, and 7A), thereby completing an electrical circuit in series with the closed electrical circuit of the voltage source, the carbon brushes, and the commutator. The continuous electrically conductive path 40 may be a strip of electrically resistive material such as carbon or may have another form that is disposed along a longitudinal axis of the media spindle. Each electrically conductive spring in electrical contact with the continuous electrically conductive path 40 decreases an amount of the electrically resistive material in the series circuit. The amount of the continuous electrically conductive path in the series circuit and therefore resistance in the series circuit increases with a decrease in a width of the media.

In FIG. 2, the media roll covers and engages the commutator and compresses electrically conductive springs 30a through 30f. Thus six additional electrical circuits in series are added to the closed electrical circuit consisting of the voltage source, the carbon brushes, and the commutator. The electrically conductive springs 30g and 30h remain uncompressed in FIG. 2.

In FIG. 3, the media roll covers and engages the commutator and compresses electrically conductive springs 30a through 30c. Electrically conductive spring 30d remains uncompressed in FIG. 3. Thus, three additional electrical circuits in series are added to the closed electrical circuit consisting of the voltage source, the carbon brushes, and the commutator. The path of electrical current 29 is shown passing through the electrical circuits connected in series in FIG. 3.

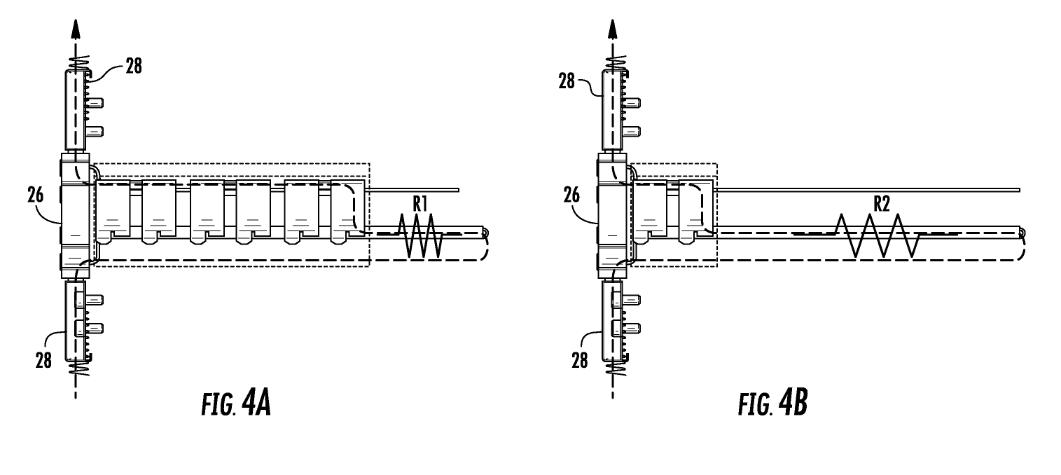

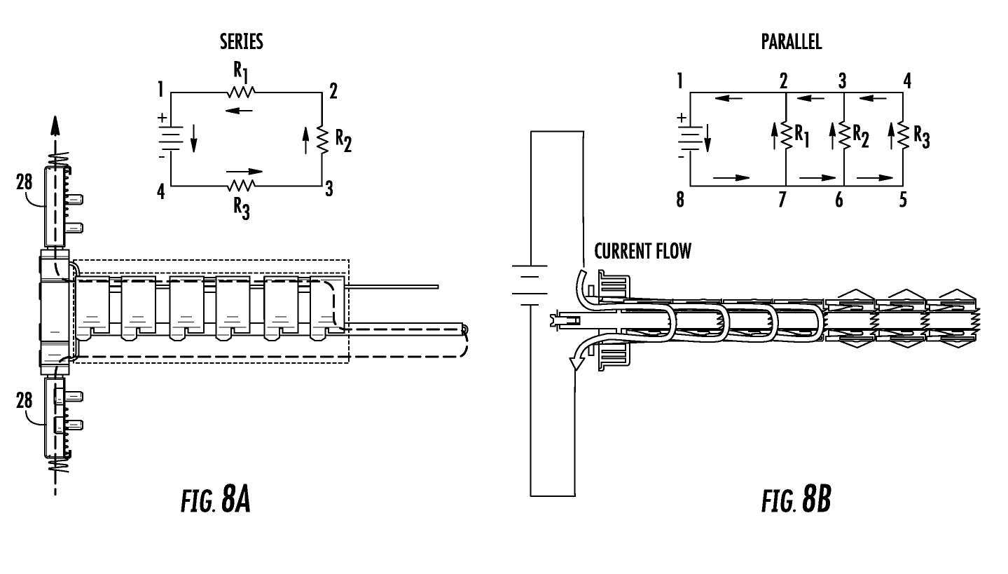

The media width is determined from the difference in electrical resistance caused by compression of the electrically conductive springs contacting the continuous electrically conductive path 40 (see, e.g., FIG. 4A versus FIG. 4B). Thus, as depicted in FIGS. 4A and 4B, the overall resistance of the series circuit will change depending on how many electrical circuits are connected in series to the closed electrical circuit. When a resistance meter is placed in the electrical circuit, the change in resistance can be measured when a media roll is loaded on the media spindle indicating how many electrically conductive springs have been compressed and thus how many electrical circuits are added to the circuit. For example, the width of the media/media roll in FIG. 4A is greater than the width of the media/media roll in FIG. 4B. Therefore, the overall resistance (R2) in FIG. 4B is greater than the resistance (R1) in FIG. 4A. FIG. 8A depicts a series circuit used in the methods according to various embodiments as compared with the conventionally used parallel circuit depicted in FIG. 8B.

Returning again to FIG. 1, according to various embodiments of the present invention, and as noted previously, the printer comprises the processor 33. The processor is configured to determine the width of the media/media roll loaded on the media spindle based upon the measured resistance as determined from the resistance circuitry (the meter). Once the media width is known to the processor, the processor causes an adjustment in media tension in accordance with the media width. The processor may be configured to send information on the width of the media/media roll loaded on the media spindle to the display on the printer.

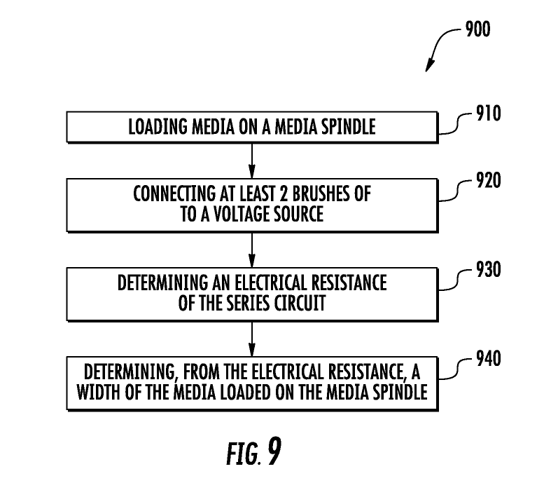

Referring now to FIG. 9, according to various embodiments of the present invention, a method 900 for controlling media tension is provided. The method 900 for controlling media tension generally comprises loading media (more particularly, the media roll) on the media spindle of the printer spindle assembly (step 910), connecting the at least two brushes to the voltage source (step 920), determining the electrical resistance of the series circuit (step 930), and determining, from the electrical resistance, a width of the media/media roll loaded on the media spindle (step 940).

Determining the electrical resistance of the series circuit comprises measuring the electrical resistance. The electrical resistance may be measured, for example, with an ohmmeter. Other ways of determining the electrical resistance of the series circuit are contemplated according to various embodiments of the present invention.

Determining the width of the media from the electrical resistance comprises identifying the width of the media that is associated with the electrical resistance. Each different electrical resistance value may be associated with a different width of the media, such as in a look-up table.

From the foregoing, it is to be appreciate that various embodiments automatically determine media width for controlling media tension. Various embodiments provide an automatic system that can sense the width of media/media roll disposed on a printer spindle assembly and feedback this information to an onboard processor that can implement torque requirements to achieve correct media tension, thereby avoiding printing problems associated with using an incorrect media tension.

To supplement the present disclosure, this application incorporates entirely by reference the following commonly assigned patents, patent application publications, and patent applications:
U.S. Pat. Nos. 6,832,725; 7,128,266;
U.S. Pat. Nos. 7,159,783; 7,413,127;
U.S. Pat. Nos. 7,726,575; 8,294,969;
U.S. Pat. Nos. 8,317,105; 8,322,622;
U.S. Pat. Nos. 8,366,005; 8,371,507;
U.S. Pat. Nos. 8,376,233; 8,381,979;
U.S. Pat. Nos. 8,390,909; 8,408,464;
U.S. Pat. Nos. 8,408,468; 8,408,469;
U.S. Pat. Nos. 8,424,768; 8,448,863;
U.S. Pat. Nos. 8,457,013; 8,459,557;
U.S. Pat. Nos. 8,469,272; 8,474,712;
U.S. Pat. Nos. 8,479,992; 8,490,877;
U.S. Pat. Nos. 8,517,271; 8,523,076;
U.S. Pat. Nos. 8,528,818; 8,544,737;
U.S. Pat. Nos. 8,548,242; 8,548,420;
U.S. Pat. Nos. 8,550,335; 8,550,354;
U.S. Pat. Nos. 8,550,357; 8,556,174;
U.S. Pat. Nos. 8,556,176; 8,556,177;
U.S. Pat. Nos. 8,559,767; 8,599,957;
U.S. Pat. Nos. 8,561,895; 8,561,903;
U.S. Pat. Nos. 8,561,905; 8,565,107;
U.S. Pat. Nos. 8,571,307; 8,579,200;
U.S. Pat. Nos. 8,583,924; 8,584,945;
U.S. Pat. Nos. 8,587,595; 8,587,697;
U.S. Pat. Nos. 8,588,869; 8,590,789;
U.S. Pat. Nos. 8,596,539; 8,596,542;
U.S. Pat. Nos. 8,596,543; 8,599,271;
U.S. Pat. Nos. 8,599,957; 8,600,158;
U.S. Pat. Nos. 8,600,167; 8,602,309;
U.S. Pat. Nos. 8,608,053; 8,608,071;
U.S. Pat. Nos. 8,611,309; 8,615,487;
U.S. Pat. Nos. 8,616,454; 8,621,123;
U.S. Pat. Nos. 8,622,303; 8,628,013;
U.S. Pat. Nos. 8,628,015; 8,628,016;
U.S. Pat. Nos. 8,629,926; 8,630,491;
U.S. Pat. Nos. 8,635,309; 8,636,200;
U.S. Pat. Nos. 8,636,212; 8,636,215;
U.S. Pat. Nos. 8,636,224; 8,638,806;
U.S. Pat. Nos. 8,640,958; 8,640,960;
U.S. Pat. Nos. 8,643,717; 8,646,692;
U.S. Pat. Nos. 8,646,694; 8,657,200;
U.S. Pat. Nos. 8,659,397; 8,668,149;
U.S. Pat. Nos. 8,678,285; 8,678,286;
U.S. Pat. Nos. 8,682,077; 8,687,282;
U.S. Pat. Nos. 8,692,927; 8,695,880;
U.S. Pat. Nos. 8,698,949; 8,717,494;
U.S. Pat. Nos. 8,717,494; 8,720,783;
U.S. Pat. Nos. 8,723,804; 8,723,904;
U.S. Pat. Nos. 8,727,223; 8,740,082;
U.S. Pat. Nos. 8,740,085; 8,746,563;
U.S. Pat. Nos. 8,750,445; 8,752,766;
U.S. Pat. Nos. 8,756,059; 8,757,495;
U.S. Pat. Nos. 8,760,563; 8,763,909;
U.S. Pat. Nos. 8,777,108; 8,777,109;
U.S. Pat. Nos. 8,779,898; 8,781,520;
U.S. Pat. Nos. 8,783,573; 8,789,757;
U.S. Pat. Nos. 8,789,758; 8,789,759;
U.S. Pat. Nos. 8,794,520; 8,794,522;
U.S. Pat. Nos. 8,794,525; 8,794,526;
U.S. Pat. Nos. 8,798,367; 8,807,431;
U.S. Pat. Nos. 8,807,432; 8,820,630;
U.S. Pat. Nos. 8,822,848; 8,824,692;
U.S. Pat. Nos. 8,824,696; 8,842,849;
U.S. Pat. Nos. 8,844,822; 8,844,823;
U.S. Pat. Nos. 8,849,019; 8,851,383;
U.S. Pat. Nos. 8,854,633; 8,866,963;
U.S. Pat. Nos. 8,868,421; 8,868,519;
U.S. Pat. Nos. 8,868,802; 8,868,803;
U.S. Pat. Nos. 8,870,074; 8,879,639;
U.S. Pat. Nos. 8,880,426; 8,881,983;
U.S. Pat. Nos. 8,881,987; 8,903,172;
U.S. Pat. Nos. 8,908,995; 8,910,870;
U.S. Pat. Nos. 8,910,875; 8,914,290;
U.S. Pat. Nos. 8,914,788; 8,915,439;
U.S. Pat. Nos. 8,915,444; 8,916,789;
U.S. Pat. Nos. 8,918,250; 8,918,564;
U.S. Pat. Nos. 8,925,818; 8,939,374;
U.S. Pat. Nos. 8,942,480; 8,944,313;
U.S. Pat. Nos. 8,944,327; 8,944,332;
U.S. Pat. Nos. 8,950,678; 8,967,468;
U.S. Pat. Nos. 8,971,346; 8,976,030;
U.S. Pat. Nos. 8,976,368; 8,978,981;
U.S. Pat. Nos. 8,978,983; 8,978,984;
U.S. Pat. Nos. 8,985,456; 8,985,457;
U.S. Pat. Nos. 8,985,459; 8,985,461;
U.S. Pat. Nos. 8,988,578; 8,988,590;
U.S. Pat. Nos. 8,991,704; 8,996,194;
U.S. Pat. Nos. 8,996,384; 9,002,641;
U.S. Pat. Nos. 9,007,368; 9,010,641;
U.S. Pat. Nos. 9,015,513; 9,016,576;
U.S. Pat. Nos. 9,022,288; 9,030,964;
U.S. Pat. Nos. 9,033,240; 9,033,242;
U.S. Pat. Nos. 9,036,054; 9,037,344;
U.S. Pat. Nos. 9,038,911; 9,038,915;
U.S. Pat. Nos. 9,047,098; 9,047,359;
U.S. Pat. Nos. 9,047,420; 9,047,525;
U.S. Pat. Nos. 9,047,531; 9,053,055;
U.S. Pat. Nos. 9,053,378; 9,053,380;
U.S. Pat. Nos. 9,058,526; 9,064,165;
U.S. Pat. Nos. 9,064,165; 9,064,167;
U.S. Pat. Nos. 9,064,168; 9,064,254;
U.S. Pat. Nos. 9,066,032; 9,070,032;
U.S. Pat. Nos. 9,076,459; 9,079,423;
U.S. Pat. Nos. 9,080,856; 9,082,023;
U.S. Pat. Nos. 9,082,031; 9,084,032;
U.S. Pat. Nos. 9,087,250; 9,092,681;
U.S. Pat. Nos. 9,092,682; 9,092,683;
U.S. Pat. Nos. 9,093,141; 9,098,763;
U.S. Pat. Nos. 9,104,929; 9,104,934;
U.S. Pat. Nos. 9,107,484; 9,111,159;
U.S. Pat. Nos. 9,111,166; 9,135,483;
U.S. Pat. Nos. 9,137,009; 9,141,839;
U.S. Pat. Nos. 9,147,096; 9,148,474;
U.S. Pat. Nos. 9,158,000; 9,158,340;
U.S. Pat. Nos. 9,158,953; 9,159,059;
U.S. Pat. Nos. 9,165,174; 9,171,543;
U.S. Pat. Nos. 9,183,425; 9,189,669;
U.S. Pat. Nos. 9,195,844; 9,202,458;
U.S. Pat. Nos. 9,208,366; 9,208,367;
U.S. Pat. Nos. 9,219,836; 9,224,024;
U.S. Pat. Nos. 9,224,027; 9,230,140;
U.S. Pat. Nos. 9,235,553; 9,239,950;
U.S. Pat. Nos. 9,245,492; 9,248,640;
U.S. Pat. Nos. 9,250,652; 9,250,712;
U.S. Pat. Nos. 9,251,411; 9,258,033;
U.S. Pat. Nos. 9,262,633; 9,262,660;
U.S. Pat. Nos. 9,262,662; 9,269,036;
U.S. Pat. Nos. 9,270,782; 9,274,812;
U.S. Pat. Nos. 9,275,388; 9,277,668;
U.S. Pat. Nos. 9,280,693; 9,286,496;
U.S. Pat. Nos. 9,298,964; 9,301,427;
U.S. Pat. Nos. 9,313,377; 9,317,037;
U.S. Pat. Nos. 9,319,548; 9,342,723;
U.S. Pat. Nos. 9,361,882; 9,365,381;
U.S. Pat. Nos. 9,373,018; 9,375,945;
U.S. Pat. Nos. 9,378,403; 9,383,848;
U.S. Pat. Nos. 9,384,374; 9,390,304;
U.S. Pat. Nos. 9,390,596; 9,411,386;
U.S. Pat. Nos. 9,412,242; 9,418,269;
U.S. Pat. Nos. 9,418,270; 9,465,967;
U.S. Pat. Nos. 9,423,318; 9,424,454;
U.S. Pat. Nos. 9,436,860; 9,443,123;
U.S. Pat. Nos. 9,443,222; 9,454,689;
U.S. Pat. Nos. 9,464,885; 9,465,967;
U.S. Pat. Nos. 9,478,983; 9,481,186;
U.S. Pat. Nos. 9,487,113; 9,488,986;
U.S. Pat. Nos. 9,489,782; 9,490,540;
U.S. Pat. Nos. 9,491,729; 9,497,092;
U.S. Pat. Nos. 9,507,974; 9,519,814;
U.S. Pat. Nos. 9,521,331; 9,530,038;
U.S. Pat. Nos. 9,572,901; 9,558,386;
U.S. Pat. Nos. 9,606,581; 9,646,189;
U.S. Pat. Nos. 9,646,191; 9,652,648;
U.S. Pat. Nos. 9,652,653; 9,656,487;
U.S. Pat. Nos. 9,659,198; 9,680,282;
U.S. Pat. Nos. 9,697,401; 9,701,140;
U.S. Design Pat. No. D702,237;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902;
U.S. Design Pat. No. D734,339;
U.S. Design Pat. No. D737,321;
U.S. Design Pat. No. D754,205;
U.S. Design Pat. No. D754,206;
U.S. Design Pat. No. D757,009;
U.S. Design Pat. No. D760,719;
U.S. Design Pat. No. D762,604;
U.S. Design Pat. No. D766,244;
U.S. Design Pat. No. D777,166;
U.S. Design Pat. No. D771,631;
U.S. Design Pat. No. D783,601;
U.S. Design Pat. No. D785,617;
U.S. Design Pat. No. D785,636;
U.S. Design Pat. No. D790,505;
U.S. Design Pat. No. D790,546;
International Publication No. 2013/163789;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2010/0265880;
U.S. Patent Application Publication No. 2011/0202554;
U.S. Patent Application Publication No. 2012/0111946;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0194692;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0332996;
U.S. Patent Application Publication No. 2014/0001267;
U.S. Patent Application Publication No. 2014/0025584;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0049120;
U.S. Patent Application Publication No. 2014/0049635;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0076974;
U.S. Patent Application Publication No. 2014/0097249;
U.S. Patent Application Publication No. 2014/0098792;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0110485;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131443;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0166759;
U.S. Patent Application Publication No. 2014/0168787;
U.S. Patent Application Publication No. 2014/0175165;
U.S. Patent Application Publication No. 2014/0191684;
U.S. Patent Application Publication No. 2014/0191913;
U.S. Patent Application Publication No. 2014/0197304;
U.S. Patent Application Publication No. 2014/0214631;
U.S. Patent Application Publication No. 2014/0217166;
U.S. Patent Application Publication No. 2014/0231500;
U.S. Patent Application Publication No. 2014/0247315;
U.S. Patent Application Publication No. 2014/0263493;
U.S. Patent Application Publication No. 2014/0263645;
U.S. Patent Application Publication No. 2014/0270196;
U.S. Patent Application Publication No. 2014/0270229;
U.S. Patent Application Publication No. 2014/0278387;
U.S. Patent Application Publication No. 2014/0288933;
U.S. Patent Application Publication No. 2014/0297058;
U.S. Patent Application Publication No. 2014/0299665;
U.S. Patent Application Publication No. 2014/0332590;
U.S. Patent Application Publication No. 2014/0351317;
U.S. Patent Application Publication No. 2014/0362184;
U.S. Patent Application Publication No. 2014/0363015;
U.S. Patent Application Publication No. 2014/0369511;
U.S. Patent Application Publication No. 2014/0374483;
U.S. Patent Application Publication No. 2014/0374485;
U.S. Patent Application Publication No. 2015/0001301;
U.S. Patent Application Publication No. 2015/0001304;
U.S. Patent Application Publication No. 2015/0009338;
U.S. Patent Application Publication No. 2015/0014416;
U.S. Patent Application Publication No. 2015/0021397;
U.S. Patent Application Publication No. 2015/0028104;
U.S. Patent Application Publication No. 2015/0029002;
U.S. Patent Application Publication No. 2015/0032709;
U.S. Patent Application Publication No. 2015/0039309;
U.S. Patent Application Publication No. 2015/0039878;
U.S. Patent Application Publication No. 2015/0040378;
U.S. Patent Application Publication No. 2015/0049347;
U.S. Patent Application Publication No. 2015/0051992;
U.S. Patent Application Publication No. 2015/0053769;
U.S. Patent Application Publication No. 2015/0062366;
U.S. Patent Application Publication No. 2015/0063215;
U.S. Patent Application Publication No. 2015/0088522;
U.S. Patent Application Publication No. 2015/0096872;
U.S. Patent Application Publication No. 2015/0100196;
U.S. Patent Application Publication No. 2015/0102109;
U.S. Patent Application Publication No. 2015/0115035;
U.S. Patent Application Publication No. 2015/0127791;
U.S. Patent Application Publication No. 2015/0128116;
U.S. Patent Application Publication No. 2015/0133047;
U.S. Patent Application Publication No. 2015/0134470;
U.S. Patent Application Publication No. 2015/0136851;
U.S. Patent Application Publication No. 2015/0142492;
U.S. Patent Application Publication No. 2015/0144692;
U.S. Patent Application Publication No. 2015/0144698;
U.S. Patent Application Publication No. 2015/0149946;
U.S. Patent Application Publication No. 2015/0161429;
U.S. Patent Application Publication No. 2015/0178523;
U.S. Patent Application Publication No. 2015/0178537;
U.S. Patent Application Publication No. 2015/0178685;
U.S. Patent Application Publication No. 2015/0181109;
U.S. Patent Application Publication No. 2015/0199957;
U.S. Patent Application Publication No. 2015/0210199;
U.S. Patent Application Publication No. 2015/0212565;
U.S. Patent Application Publication No. 2015/0213647;
U.S. Patent Application Publication No. 2015/0220753;
U.S. Patent Application Publication No. 2015/0220901;
U.S. Patent Application Publication No. 2015/0227189;
U.S. Patent Application Publication No. 2015/0236984;
U.S. Patent Application Publication No. 2015/0239348;
U.S. Patent Application Publication No. 2015/0242658;
U.S. Patent Application Publication No. 2015/0248572;
U.S. Patent Application Publication No. 2015/0254485;
U.S. Patent Application Publication No. 2015/0261643;
U.S. Patent Application Publication No. 2015/0264624;
U.S. Patent Application Publication No. 2015/0268971;
U.S. Patent Application Publication No. 2015/0269402;
U.S. Patent Application Publication No. 2015/0288689;
U.S. Patent Application Publication No. 2015/0288896;
U.S. Patent Application Publication No. 2015/0310243;
U.S. Patent Application Publication No. 2015/0310244;
U.S. Patent Application Publication No. 2015/0310389;
U.S. Patent Application Publication No. 2015/0312780;
U.S. Patent Application Publication No. 2015/0327012;
U.S. Patent Application Publication No. 2016/0014251;
U.S. Patent Application Publication No. 2016/0025697;
U.S. Patent Application Publication No. 2016/0026838;
U.S. Patent Application Publication No. 2016/0026839;
U.S. Patent Application Publication No. 2016/0040982;
U.S. Patent Application Publication No. 2016/0042241;
U.S. Patent Application Publication No. 2016/0057230;
U.S. Patent Application Publication No. 2016/0062473;
U.S. Patent Application Publication No. 2016/0070944;
U.S. Patent Application Publication No. 2016/0092805;
U.S. Patent Application Publication No. 2016/0101936;
U.S. Patent Application Publication No. 2016/0104019;
U.S. Patent Application Publication No. 2016/0104274;
U.S. Patent Application Publication No. 2016/0109219;
U.S. Patent Application Publication No. 2016/0109220;
U.S. Patent Application Publication No. 2016/0109224;
U.S. Patent Application Publication No. 2016/0112631;
U.S. Patent Application Publication No. 2016/0112643;
U.S. Patent Application Publication No. 2016/0117627;
U.S. Patent Application Publication No. 2016/0124516;
U.S. Patent Application Publication No. 2016/0125217;
U.S. Patent Application Publication No. 2016/0125342;
U.S. Patent Application Publication No. 2016/0125873;
U.S. Patent Application Publication No. 2016/0133253;
U.S. Patent Application Publication No. 2016/0171597;
U.S. Patent Application Publication No. 2016/0171666;
U.S. Patent Application Publication No. 2016/0171720;
U.S. Patent Application Publication No. 2016/0171775;
U.S. Patent Application Publication No. 2016/0171777;
U.S. Patent Application Publication No. 2016/0174674;
U.S. Patent Application Publication No. 2016/0178479;
U.S. Patent Application Publication No. 2016/0178685;
U.S. Patent Application Publication No. 2016/0178707;
U.S. Patent Application Publication No. 2016/0179132;
U.S. Patent Application Publication No. 2016/0179143;
U.S. Patent Application Publication No. 2016/0179368;
U.S. Patent Application Publication No. 2016/0179378;
U.S. Patent Application Publication No. 2016/0180130;
U.S. Patent Application Publication No. 2016/0180133;
U.S. Patent Application Publication No. 2016/0180136;
U.S. Patent Application Publication No. 2016/0180594;
U.S. Patent Application Publication No. 2016/0180663;
U.S. Patent Application Publication No. 2016/0180678;
U.S. Patent Application Publication No. 2016/0180713;
U.S. Patent Application Publication No. 2016/0185136;
U.S. Patent Application Publication No. 2016/0185291;
U.S. Patent Application Publication No. 2016/0186926;
U.S. Patent Application Publication No. 2016/0188861;
U.S. Patent Application Publication No. 2016/0188939;
U.S. Patent Application Publication No. 2016/0188940;
U.S. Patent Application Publication No. 2016/0188941;
U.S. Patent Application Publication No. 2016/0188942;
U.S. Patent Application Publication No. 2016/0188943;
U.S. Patent Application Publication No. 2016/0188944;
U.S. Patent Application Publication No. 2016/0189076;
U.S. Patent Application Publication No. 2016/0189087;
U.S. Patent Application Publication No. 2016/0189088;
U.S. Patent Application Publication No. 2016/0189092;
U.S. Patent Application Publication No. 2016/0189284;
U.S. Patent Application Publication No. 2016/0189288;
U.S. Patent Application Publication No. 2016/0189366;
U.S. Patent Application Publication No. 2016/0189443;
U.S. Patent Application Publication No. 2016/0189447;
U.S. Patent Application Publication No. 2016/0189489;
U.S. Patent Application Publication No. 2016/0192051;
U.S. Patent Application Publication No. 2016/0202951;
U.S. Patent Application Publication No. 2016/0202958;
U.S. Patent Application Publication No. 2016/0202959;
U.S. Patent Application Publication No. 2016/0203021;
U.S. Patent Application Publication No. 2016/0203429;
U.S. Patent Application Publication No. 2016/0203797;
U.S. Patent Application Publication No. 2016/0203820;
U.S. Patent Application Publication No. 2016/0204623;
U.S. Patent Application Publication No. 2016/0204636;
U.S. Patent Application Publication No. 2016/0204638;
U.S. Patent Application Publication No. 2016/0227912;
U.S. Patent Application Publication No. 2016/0232891;
U.S. Patent Application Publication No. 2016/0292477;
U.S. Patent Application Publication No. 2016/0294779;
U.S. Patent Application Publication No. 2016/0306769;
U.S. Patent Application Publication No. 2016/0314276;
U.S. Patent Application Publication No. 2016/0314294;
U.S. Patent Application Publication No. 2016/0316190;
U.S. Patent Application Publication No. 2016/0323310;
U.S. Patent Application Publication No. 2016/0325677;
U.S. Patent Application Publication No. 2016/0327614;
U.S. Patent Application Publication No. 2016/0327930;
U.S. Patent Application Publication No. 2016/0328762;
U.S. Patent Application Publication No. 2016/0330218;
U.S. Patent Application Publication No. 2016/0343163;
U.S. Patent Application Publication No. 2016/0343176;
U.S. Patent Application Publication No. 2016/0364914;
U.S. Patent Application Publication No. 2016/0370220;
U.S. Patent Application Publication No. 2016/0372282;
U.S. Patent Application Publication No. 2016/0373847;
U.S. Patent Application Publication No. 2016/0377414;
U.S. Patent Application Publication No. 2016/0377417;
U.S. Patent Application Publication No. 2017/0010141;
U.S. Patent Application Publication No. 2017/0010328;
U.S. Patent Application Publication No. 2017/0010780;
U.S. Patent Application Publication No. 2017/0016714;
U.S. Patent Application Publication No. 2017/0018094;
U.S. Patent Application Publication No. 2017/0046603;
U.S. Patent Application Publication No. 2017/0047864;
U.S. Patent Application Publication No. 2017/0053146;
U.S. Patent Application Publication No. 2017/0053147;
U.S. Patent Application Publication No. 2017/0053647;
U.S. Patent Application Publication No. 2017/0055606;
U.S. Patent Application Publication No. 2017/0060316;
U.S. Patent Application Publication No. 2017/0061961;
U.S. Patent Application Publication No. 2017/0064634;
U.S. Patent Application Publication No. 2017/0083730;
U.S. Patent Application Publication No. 2017/0091502;
U.S. Patent Application Publication No. 2017/0091706;
U.S. Patent Application Publication No. 2017/0091741;
U.S. Patent Application Publication No. 2017/0091904;
U.S. Patent Application Publication No. 2017/0092908;
U.S. Patent Application Publication No. 2017/0094238;
U.S. Patent Application Publication No. 2017/0098947;
U.S. Patent Application Publication No. 2017/0100949;
U.S. Patent Application Publication No. 2017/0108838;
U.S. Patent Application Publication No. 2017/0108895;
U.S. Patent Application Publication No. 2017/0118355;
U.S. Patent Application Publication No. 2017/0123598;
U.S. Patent Application Publication No. 2017/0124369;
U.S. Patent Application Publication No. 2017/0124396;
U.S. Patent Application Publication No. 2017/0124687;
U.S. Patent Application Publication No. 2017/0126873;
U.S. Patent Application Publication No. 2017/0126904;
U.S. Patent Application Publication No. 2017/0139012;
U.S. Patent Application Publication No. 2017/0140329;
U.S. Patent Application Publication No. 2017/0140731;
U.S. Patent Application Publication No. 2017/0147847;
U.S. Patent Application Publication No. 2017/0150124;
U.S. Patent Application Publication No. 2017/0169198;
U.S. Patent Application Publication No. 2017/0171035;
U.S. Patent Application Publication No. 2017/0171703;
U.S. Patent Application Publication No. 2017/0171803;
U.S. Patent Application Publication No. 2017/0180359;
U.S. Patent Application Publication No. 2017/0180577;
U.S. Patent Application Publication No. 2017/0181299;
U.S. Patent Application Publication No. 2017/0190192;
U.S. Patent Application Publication No. 2017/0193432;
U.S. Patent Application Publication No. 2017/0193461;
U.S. Patent Application Publication No. 2017/0193727;
U.S. Patent Application Publication No. 2017/0199266;
U.S. Patent Application Publication No. 2017/0200108; and
U.S. Patent Application Publication No. 2017/0200275.

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A printer spindle assembly comprising:
a media spindle having a first end and a second end;
a commutator disposed circumferentially at the first end of the media spindle;
at least two brushes in electrical contact with the commutator and connected to a voltage source, the voltage source, the at least two brushes, and the commutator forming a closed electrical circuit;
a plurality of electrically conductive springs serially disposed on the media spindle in electrical communication with the commutator, wherein each electrically conductive spring is configured to be in an uncompressed state in the absence of media on the media spindle and one or more of the electrically conductive springs is configured to be in a compressed state in the presence of the media on the media spindle; and
a continuous electrically conductive path formed of electrically resistive material disposed along a longitudinal axis of the media spindle and configured to be in electrical contact with a first spring end of the one or more electrically conductive springs in the compressed state to form a series circuit.

2. The printer spindle assembly according to claim 1, wherein each conductive spring in electrical contact with the continuous electrically conductive path decreases an amount of the electrically resistive material in the series circuit.

3. The printer spindle assembly according to claim 2, wherein the amount of the electrically resistive material in the series circuit and therefore resistance in the series circuit increases with a decrease in a width of the media.

4. The printer spindle assembly according to claim 1, wherein the media spindle includes a groove for receiving a second spring end of each electrically conductive spring.

5. The printer spindle assembly according to claim 1, wherein the media spindle comprises a nonconductive material and each electrically conductive spring is metallic.

6. The printer spindle assembly according to claim 1, wherein the plurality of electrically conductive springs, each electrically conductive spring comprising a pair of conjoined spring portions having a space therebetween to impart compressibility to each electrically conductive spring.

7. The printer spindle assembly according to claim 3, wherein the printer further comprises a processor configured to determine a width of the media loaded on the media spindle based on the resistance of the series circuit and configured to adjust torsion on the media based upon the determined width of the media.

8. The printer spindle assembly according to claim 7, wherein the processor is further configured to send information on the width of the media loaded on the media spindle to a printer display.

9. The printer spindle assembly according to claim 1, wherein the printer further comprises a processor and the closed electrical circuit connects the series circuit to a main electrical control unit housing the processor.

10. The printer spindle assembly according to claim 1, wherein the media spindle, the plurality of electrically conductive springs, and the electrically resistive material collectively comprise a rotational potentiometer.

11. A printer comprising:
a spindle assembly comprising:
a media spindle having a first end and a second end;
a commutator disposed circumferentially at the first end of the media spindle;
at least two brushes in electrical contact with the commutator and connected to a voltage source, the voltage source, the at least two brushes, and the commutator forming a closed electrical circuit;
a plurality of electrically conductive springs serially disposed on the media spindle in electrical communication with the commutator, wherein each electrically conductive spring is configured to be in an uncompressed state in the absence of media on the media spindle and one or more of the conductive springs is configured to be in a compressed state in the presence of the media on the media spindle; and
a continuous electrically conductive path formed of electrically resistive material disposed along a longitudinal axis of the media spindle and configured to be in electrical contact with a first spring end of the one or more electrically conductive springs in the compressed state to form a series circuit; and
a processor configured to determine a width of the media loaded on the media spindle based on the resistance of the series circuit and configured to adjust torsion on the media based upon the determined width of the media.

12. The printer according to claim 11, wherein each conductive spring in electrical contact with the continuous electrically conductive path decreases an amount of the electrically resistive material in the series circuit.

13. The printer according to claim 12, wherein the amount of the electrically resistive material in the series circuit and therefore resistance in the series circuit increases with a decrease in a width of the media.

14. The printer according to claim 11, wherein the media spindle includes a groove for receiving a second spring end of each electrically conductive spring.

15. The printer according to claim 11, wherein the media spindle comprises a nonconductive material and each electrically conductive spring is metallic.

16. The printer according to claim 11, wherein the plurality of electrically conductive springs, each electrically conductive spring comprising a pair of conjoined spring portions having a space therebetween to impart compressibility to each electrically conductive spring.

17. The printer according to claim 11, wherein the media spindle, the plurality of electrically conductive springs, and the electrically resistive material collectively comprise a rotational potentiometer.

18. A method comprising:
loading media on a media spindle of a printer spindle assembly, the media spindle having a first end and a second end and the printer spindle assembly comprising:
a commutator disposed circumferentially at the first end of the media spindle;
at least two brushes in electrical contact with the commutator and connected to a voltage source, the voltage source, the at least two brushes, and the commutator forming a closed electrical circuit;
a plurality of electrically conductive springs serially disposed on the media spindle in electrical communication with the commutator, wherein each electrically conductive spring is configured to be in an uncompressed state in the absence of the media on the media spindle and one or more of the electrically conductive springs is configured to be in a compressed state in the presence of the media on the media spindle; and
a continuous electrically conductive path formed of electrically resistive material disposed along a longitudinal axis of the media spindle and configured to be in electrical contact with a first spring end of the one or more electrically conductive springs in the compressed state to form a series circuit;
connecting the at least two brushes to a voltage source;
determining an electrical resistance of the series circuit; and
determining, from the electrical resistance, a width of the media loaded on the media spindle.

19. The method according to claim 18, wherein determining the width from the electrical resistance comprises identifying the width of the media that is associated with the electrical resistance.

20. The method according to claim 19, wherein each different electrical resistance value is associated with a different width of the media.
